(19) United States
(12) Patent Application Publication
(10) Pub. No.: US 2024/0283082 A1
(43) Pub. Date: Aug. 22, 2024

(54) Battery Module Having Storage for Venting Particle

(71) Applicant: SAMSUNG SDI CO., LTD., Yongin-si (KR)

(72) Inventor: Wolfgang Reinprecht, Attendorf (AT)

(21) Appl. No.: 18/495,693

(22) Filed: Oct. 26, 2023

(30) Foreign Application Priority Data
Feb. 17, 2023 (EP) 23157377.5

(51) Int. Cl. H01M 50/358; H01M 50/209

(52) U.S. Cl. CPC H01M 50/358; H01M 50/209; H01M 2200/20; H01M 2220/20

(57) ABSTRACT

A battery module includes: a battery cell stack including a plurality of battery cells arranged along a first direction, each of the battery cells having a venting side including a venting outlet and facing in a second direction crossing the first direction; a venting space extending adjacent to the venting sides with the venting outlets opening into the venting space; a degassing space extending along the first direction besides the venting space; and a plurality of separators sub-dividing the venting space into a plurality of venting channels arranged along the first direction and being gas-tightly separated from each other by the separators. Each of the venting channels has a venting channel opening open into the degassing space, and the degassing space is at least partly confined by a wall including a collection area arranged opposite to and spaced apart from the venting channel openings.

### CROSS-REFERENCE TO RELATED APPLICATION

This application claims priority to and the benefit of European Patent Application No. 23157377.5, filed in the European Patent Office on Feb. 17, 2023, the entire content of which is incorporated herein by reference.

### BACKGROUND

### 1. Field

Aspects of embodiments of the present disclosure relate to a battery module having a storage for venting particles.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent electric vehicles in development.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

A battery system may further include a battery management system (BMS), which is any electronic system that manages the rechargeable battery, battery module, and battery pack, such as by protecting the batteries from operating outside their safe operating area, monitoring their states, calculating secondary data, reporting that data, controlling its environment, authenticating it, and/or balancing it. For example, the BMS may monitor the state of the battery as represented by voltage (such as the total (or overall) voltage of the battery pack or battery modules, voltages of individual cells, etc.), temperature (such as average temperature of the battery pack or battery modules, coolant intake temperature, coolant output temperature, or temperatures of individual cells), coolant flow (such as flow rate, cooling liquid pressure, etc.), and current. Additionally, the BMS may calculate values based on the above characteristics or measured values, such as minimum and maximum cell voltage, state of charge (SOC) or depth of discharge (DOD) to indicate the charge level of the battery, state of health (SOH; a variously-defined measurement of the remaining capacity of the battery as a percent of the original capacity), state of power (SOP; the amount of power available for a defined time interval given the current power usage, temperature, and other conditions), state of safety (SOS), maximum charge current as a charge current limit (CCL), maximum discharge current as a discharge current limit (DCL), and internal impedance of a cell (to determine open circuit voltage).

The BMS may be centralized, meaning that a single controller (e.g., a single BMS) is connected to the battery cells via a multitude of wires. The BMS may be also distributed, which means that a BMS board is installed at each cell and only a single communication cable connects the battery and a controller. Alternatively, the BMS may have a modular construction including a few controllers, each handling a certain number of (e.g., a group of) cells with communication between the controllers. Centralized BMSs are most economical but are the least expandable and are plagued by a multitude of wires. Distributed BMSs are the most expensive but are the simplest to install and offer the cleanest assembly. Modular BMSs offer a compromise of the features and problems of the other two topologies.

A BMS may protect the battery pack from operating outside its safe operating area. Operation outside the safe operating area may be indicated by over-current, over-voltage (during charging), over-temperature, under-temperature, over-pressure, and ground fault or leakage current detection. The BMS may prevent the battery from operating outside its safe operating parameters by including an internal switch (e.g., a relay or solid-state device) that opens if the battery is operated outside its safe operating parameters, requesting the devices to which the battery is connected to reduce or even terminate using the battery, and actively controlling the environment, such as through heaters, fans, air conditioning or liquid cooling.

Mechanical integration of such a battery pack incorporates suitable mechanical connections between the individual components of, for example, battery modules, and between them and a supporting structure of the vehicle. These connections are designed to remain functional and safe throughout the average service life of the battery system. Furthermore, installation space and interchangeability standards must be considered, especially in mobile applications.

Mechanical integration of battery modules may be achieved by providing a carrier framework and by positioning the battery modules thereon. Fixing the battery cells or battery modules may be achieved by using fitted depressions in the framework or by mechanical interconnectors, such as bolts or screws. In other examples, the battery modules are confined by fastening side plates to lateral sides of the carrier framework. Moreover, cover plates may be fixed atop and below the battery modules.

The carrier framework of the battery pack is mounted to a carrying structure of the vehicle. When the battery pack is fixed at the bottom of the vehicle, the mechanical connection may be established from the bottom side by, for example, bolts passing through the carrier framework of the battery pack. The framework is generally made of aluminum or an aluminum alloy to lower the total weight of the construction.

Related art battery systems, despite any modular structure, usually include a battery housing that acts as enclosure to seal the battery system against the environment and provides structural protection of the battery system's components.

For meeting the dynamic power demands of various electrical consumers connected to the battery system a static control of battery power output and charging is not sufficient. Thus, steady exchange of information between the battery system and the controllers of the electrical consumers is required. This information includes the battery systems actual state of charge, SoC, potential electrical performance, charging ability and internal resistance as well as actual or predicted power demands or surpluses of the consumers. Therefore, battery systems usually comprise a battery management system, BMS, for obtaining and processing such information on system level and further a plurality of battery module managers, BMMs, which are part of the system's battery modules and obtain and process relevant information on module level. Particularly, the BMS usually measures the system voltage, the system current, the local temperature at different places inside the system housing, and the insulation resistance between live components and the system housing. Additionally, the BMMs usually measure the individual cell voltages and temperatures of the battery cells in a battery module.

An active or passive thermal management system to provide thermal control of the battery pack is often included to safely use the at least one battery module by efficiently emitting, discharging, and/or dissipating heat generated from its rechargeable batteries. If the heat emission, discharge, and/or dissipation is not sufficiently performed, temperature deviations may occur between respective battery cells, such that the battery module may no longer generate a desired (or designed) amount of power. In addition, an increase of the internal temperature can lead to abnormal reactions occurring therein, and thus, charging and discharging performance of the rechargeable deteriorates and the life-span of the rechargeable battery is shortened. Thus, cell cooling for effectively emitting, discharging, and/or dissipating heat from the cells is important.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. These exothermic reactions include combustion of flammable gas compositions within the battery housing. For example, when a cell is heated above a critical temperature (typically above about 150° C.), the cell can transition into a thermal runaway. The initial heating may be caused by a local failure, such as a cell internal short circuit, heating from a defective electrical contact, or short circuit to a neighboring cell. During the thermal runaway, a failed battery cell, such as a battery cell that has a local failure, may reach a temperature exceeding about 700° C. Further, large quantities of hot gas are ejected (or emitted) from inside of the failed battery cell through the venting opening in the battery housing into the battery pack. The main components of the vented gas are H₂, CO₂, CO, electrolyte vapor, and other hydrocarbons. The vented gas is therefore flammable and potentially toxic. The vented gas also causes a gas-pressure to increase inside the battery pack.

Furthermore, internal parts of an affected battery cell may melt during a thermal runaway, and dust including solid particles, such as metallic (e.g., copper) and/or graphite particles may be generated. The dust is then ejected (or emitted) together with the venting gas and may deteriorate or even destroy electric components (such as terminals of the battery cells) within the battery module and even outside the battery module after being discharged from the battery module. Also, because the dust includes metallic and/or graphite particles, short circuits and/or arcs may be caused due to resistive shorts between high voltage parts within the battery module or battery pack or between high voltage parts and the chassis of the vehicle. Such short circuits and/or arcs present a serious risk to people in the vicinity of the vehicle. Thus, such short circuits and/or arcs between members within the battery module or battery pack and between high voltage parts of the battery system and the chassis should be avoided.

The term “thermal propagation” denotes an event that occurs when the thermal runaway of one battery cell initiates thermal runaway in one or more other (e.g., adjacent) battery cells. This may lead to a chain reaction, in the course of which the entire battery pack and, possibly, its surrounding (e.g., a vehicle) burn down.

Related art venting designs of a battery system exploit the free space (e.g., expansion volume) inside a battery cell stack such that the vent gas can follow along the free space to the exit of the battery pack into the free ambient air. Before being discharged into the ambient air, the vent gas passes a venting valve, which acts as a final “door” (or baffle) for the venting gas to the outside of the battery pack. A battery system is considered to be robust if, in the case of thermal propagation, the vent gas or smoke outside the battery pack does not ignite and, thus, will not cause a fire for at least a certain (e.g., predefined) period of time. However, in modern battery modules, in particular in battery modules configured for the use in hybrid vehicles, the expansion volume often is not sufficient, which increases the risk of short circuits and arcs.

### SUMMARY

There is a need for a battery module, a battery pack, and vehicles using one or both of the latter, that is configured to avoid or at least substantially reduce the risk of short circuits and/or arcs between members within the battery module or battery pack and also between high voltage parts of the battery system and the chassis of the vehicle.

Embodiments of the present disclosure overcome or reduce at least some of the drawbacks of the related art and provide a battery module, a battery pack, and a vehicle using the same. The battery module, the battery pack, and the vehicle according to embodiments of the present disclosure are each configured to avoid or at least substantially reduce the risk of short circuits and/or arcs between members within the battery module or battery pack and also between high voltage parts of the battery system and the chassis of the vehicle.

A battery module, according to an embodiment of the present disclosure, includes: a battery cell stack including a plurality of battery cells (e.g., prismatically shaped battery cells) arranged along a first direction, each of the battery cells having a venting side, each of the venting sides facing in a second direction crossing the first direction, each of the venting sides including a venting outlet; a venting space extending along the battery cell stack adjacent to the venting sides, each of the venting outlets opening into the venting space; a degassing space extending along the first direction besides the venting space; a plurality of separators arranged within the venting space and sub-dividing the venting space into a plurality of venting channels arranged along the first direction and being gas-tightly separated from each other by the separators. Each of the venting channels has a venting channel opening that opens into the degassing space, and the degassing space is at least partly confined by a wall including a collection area. The collection area is arranged opposite to each of the venting channel openings and spaced apart from each of the venting channel openings.

A battery system, according to another embodiment of the present disclosure, includes one or more battery modules as described above.

A vehicle, according to an embodiment of the present disclosure, includes at least one battery module and/or at least one battery system as described above.

Further aspects and features of the present disclosure can be learned from the appended claims and the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic perspective view of a battery cell according to embodiments of the present disclosure;

FIG. 2 is a schematic cross-sectional view of a battery module according to an embodiment of the present disclosure;

FIG. 3 is a schematic cross-sectional view taken through a venting space of the battery module shown in FIG. 2;

FIG. 4 is a schematic cross-sectional view of the battery module shown in FIGS. 2 and 3.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. Therefore, processes, elements, and techniques that are not considered necessary for those having ordinary skill in the art to have a complete understanding of the aspects and features of the present disclosure may not be described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized”, respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Features of the disclosed concept and methods of accomplishing the same may be understood more readily by reference to the following detailed description of embodiments and the accompanying drawings. Hereinafter, example embodiments will be described in more detail with reference to the accompanying drawings. The subject-matter of the present disclosure, however, may be embodied in various different forms, and should not be construed as being limited to only the illustrated embodiments herein. Rather, these embodiments are provided as examples so that this disclosure will be thorough and complete and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof will not be repeated.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements (e.g., on a PCB or another kind of circuit carrier). The conducting elements may comprise metallization, e. g., surface metallizations and/or pins, and/or may comprise conductive polymers or ceramics. Further electrical energy might be transmitted via wireless connections (e.g., using electromagnetic radiation and/or light).

Further, the various components of these electronic or electric devices may be a process or thread, running on one or more processors, in one or more computing devices, executing computer program instructions and interacting with other system components for performing the various functionalities described herein. The computer program instructions are stored in a memory, which may be implemented in a computing device using a standard memory device, such as a random-access memory (RAM). The computer program instructions may also be stored in other non-transitory computer readable media, such as, for example, a CD-ROM, flash drive, or the like.

Also, a person of skill in the art should recognize that the functionality of various computing devices may be combined or integrated into a single computing device, or the functionality of a particular computing device may be distributed across one or more other computing devices without departing from the scope of the exemplary embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

A first embodiment of the present disclosure is related to a battery module. The battery module includes a battery cell stack including a plurality of battery cells (each of the battery cells may have a prismatic shape) arranged along a first direction. Each of the battery cells has a venting side, and each of the venting sides faces in a second direction oriented non-parallel to (e.g., crossing) the first direction. Each of the venting sides includes a venting outlet. A venting space extends along the battery cell stack adjacent to the venting sides, and each of the venting outlets opens into the venting space. A degassing space extends along the first direction besides (or adjacent to) the venting space. A plurality of separators is arranged within the venting space to sub-divide the venting space into a plurality of venting channels arranged (e.g., arranged consecutively) along the first direction and being separated from each other by the separators in a gas-tight manner. Each of the venting channels has a venting channel opening, which opens into the degassing space. The degassing space is at least partly confined by a wall having (or forming) a collection area, and the collection area may be arranged opposite to each of the venting channel openings and spaced apart from each of the venting channel openings.

The battery module may be used as a power source or as a part of a power source for a hybrid vehicle or a fully electric vehicle.

Herein, the term “venting side” is short for “venting side face,” that is, the expression refers to the side face of a prismatic battery cell that on which a venting outlet is formed. It is assumed that only one of a battery cell's side faces has a venting outlet, but the present disclosure is not limited thereto. Inside a battery cell, a valve is usually installed upstream of the outlet, and the valve is configured to open when the gas pressure inside the battery cell exceeds a reference (or predefined) value but remains in a closed stated normally.

Also, in embodiments, each or at least some of the venting sides may be essentially planar.

Further, the term “separated in a gas-tight manner” and variations thereof means that venting gas in one of the venting channels cannot enter (e.g., flow) into the neighboring venting channels. For example, any exchange of vent gas and/or particles between any two neighboring venting channels is inhibited. Thus, in the venting channels that are arranged consecutively along the first direction, an exchange of vent gas and/or particles entrained with the vent gas between different (e.g., adjacent) venting channels is inhibited.

According to the aforementioned structure, in the case of a thermal event, such as a thermal runaway, vent gas, which may include particles, is ejected (or emitted) from the venting outlet of a battery cell and enters into the venting space. The vent gas is collected first in one of the venting channels formed within the venting space by the separators. Then, the vent gas effuses from the respective venting channel into the degassing space via the venting channel opening of the venting channel. After this, because the collection area is arranged opposite to each of the venting channel openings and spaced apart from each of the venting channel openings, particles entrained along with the vent gas impinge on the collection area arranged opposite to the venting channel opening of the venting channel, from which the vent gas is effused. Therefore, the particles may stick at the collection area while the vent gas—now without the particles—may pass further through the degassing space to be finally discharged from the degassing space. In other words, the particles are separated from the pure vent gas by this process enabled by the battery module as described herein. As a result, the pure vent gas is then discharged from the battery module while the particles remain inside the battery module stuck or even sintered onto the collection area.

The process of the particles sticking or sintering on the collection area after having impinged against the collection area may be supported or improved by the high temperature and/or high kinetic energy of the particles. This is normally the case during a thermal event, such as a thermal runaway, due to the rather high energies and pressures arising inside a battery cell during such an event, as has been already described above in the introductory part. As described below in the context of certain embodiments, the kinetic energy of the particles can be increased by the shape of the venting channel outlet.

The term “non-parallel” with regard to two directions means that the angle between the two directions is not equal to 0° and also not equal to 180°. Further, the term “non-parallel” with regard to a direction and a plane means that the direction has an angle not equal to 0° or 180° with regard to the direction or the plane.

By collecting the particles (e.g., metallic and graphite particles) flowing with (or in) the vent gas stream inside the battery module at an electrically neutral region s prevents any kind of short circuit and/or arcing due to a resistive short between high voltage parts. Then, the hot metallic and graphite particles get “sintered” at an area of a wall (e.g., a metal area) and remain stuck there. Thus, these particles are then impeded from moving further and, hence, never exit the battery module where they could cause a fire outside or arcing.

Thus, the battery module according to the above-described first embodiment is configured to prevent the particles (such as metallic and graphite particles) ejected from a cell during thermal runaway by retaining the particles at different locations within the battery module to prevent these particles from exiting the battery module and from possibly igniting the venting gas outside of the module.

In some embodiments, the second direction is perpendicular to the first direction.

In one embodiment of the battery module, the separators are each planar or essentially planar, and the separators are each arranged parallel to a border between two adjacent battery cells.

Here, the term “border” between two adjacent battery cells may refer to a plane between two battery cells abutting against each other in the battery cell stack or, if neighboring battery cells do not abut or do not necessarily abut against each other in the battery cell stack, refers to an interstice between those neighbored battery cells.

Then, the venting outlets of one battery cell or a group of neighboring battery cells open into the same venting channel. Consequently, vent gas ejected by one battery cell is inhibited from contacting the surface of battery cells in other groups of battery cells (e.g., groups of battery cells that do not open into the venting channel) into which the vent gas of the one battery cell is ejected.

The separators may be positioned such that groups of several battery cells are located between any two adjacent separators. For example, each of the groups may include one battery cell, two battery cells, three battery cells, four battery cells, five battery cells, six battery cells, or more. In one embodiment, the battery cells in the battery cell stack are electrically connected in series, and the battery cells are grouped into groups each including three or four battery cells. In such an embodiment, the potential difference between the first and the last battery cell in the group is too small to cause an arc.

In embodiments, the planar separators may be arranged perpendicular to the first direction. Alternatively or additionally, the planar separator may be arranged parallel to the second direction.

In one embodiment, the battery module further includes a confining member. The confining member confines at least a part of the venting space. The confining member is made of a material that is impermeable to venting particles. In other words, the confining member is configured to shield the venting particles and, thus, forms a spatial barrier for the venting particles.

In some embodiments, the confining member is made of a high-temperature resistant material.

In embodiments, the confining member may confine the entire venting space except for the areas of the venting outlets on the battery cell's venting sides and the venting channel openings leading into the degassing space. In other embodiments, the venting space may be partly confined by the venting sides of the battery cells. In such embodiments, the confining member confines the venting space in each direction, except for those inner surface areas of the venting space that are already confined by the venting sides of the battery cells and in the areas of the venting channel openings.

In embodiments, at least a part of the venting channel openings may simply be formed by a hole the confining member at an area where the confining member is arranged adjacent to the degassing space.

In other embodiments of the battery module, at least for some of the venting channels, the respective venting channel opening is formed by a duct having a smaller cross-section than that of the respective venting channel.

Here, the cross-sections may be taken along a virtual plane arranged parallel to the first and second direction. Also, the cross-sections may be taken along a virtual plane arranged non-parallel to the third direction. Also, the cross-sections may each be taken along a virtual plane perpendicular to the third direction.

In other words, the duct may be narrower than the venting channel. Hence, upon discharging vent gas via the venting channel openings from the venting channel into the degassing space, the vent gas is accelerated as it flows through the duct according to the continuity equation of continuum mechanics or fluid dynamics. As a result, the vent gas as well as the particles entrained within the vent gas can be accelerated to have sufficient kinetic energy when leaving the venting channel opening to reach the collection area opposite to the venting channel openings on the other side (with respect to the third direction) of the degassing space. Of course, to obtain the kinetic energy of the vent gas and the particles, the pressure of vent gas in the venting channel has to be considered, which in turn depends on the flux of the vent gas entering the venting channel, the volume of the venting chamber, and the temperature of the vent gas inside the venting channel.

In embodiments, the duct may have a tapered shape when viewed in a direction from the venting channel through the venting channel opening into the degassing space (e.g., in the flow direction of the vent gas). Then, again due to the continuity equation, the vent gas including the entrained particles is increasingly accelerated while streaming (or flowing) through the tapered duct and is effused from the venting channel opening into the degassing space with a high velocity.

In one embodiment of the battery module, at least some of the ducts are each formed by a narrowed portion of the confining member.

In one embodiment of the battery module, the confining member includes a first cover that is spaced apart, at least partially, from the venting sides and confines the venting space with respect to the second direction. In other words, in such an embodiment, the venting space is arranged between (or formed between) the first cover and the venting sides of the battery cells.

The above does not exclude, however, embodiments in which a second cover is arranged, as another part of the confining member, between the venting sides of the battery cells and the venting space. In such an embodiment, the second cover a may have a plurality of openings such that vent gas ejected from the venting outlets of one or more of the individual battery cells is able to stream into the venting space through at least one of these openings. Then, each of the openings in the second cover is arranged in line with one of the venting openings in the battery cells, when viewed along a direction perpendicular to the venting sides of the battery cells. Another type of a second cover will be described in detail below.

In one embodiment of the battery module, the venting side of each battery cell includes a first terminal. Further, for each of the battery cells, the first cover gas-tightly connects to the venting side of the battery cell between the position of the first terminal and the position of the venting outlet.

In such embodiments, the first terminal of each of the battery cells is shielded from the vent gas and the entrained particles by the first cover such that the vent gas and/or the particles cannot destroy or deteriorate the first terminal in the event of an ejection of vent gas and/or particles out of the venting outlet.

In one embodiment of the battery module, the venting side of each battery cell includes a second terminal. The confining member may include a second cover. For each of the battery cells, the second cover gas-tightly connects to the venting side of the battery cell between the position of the second terminal and the position of the venting outlet.

In such embodiments, the second terminal of each of the battery cells is shielded from the vent gas and the entrained particles by the second cover such that the vent gas and/or the particles cannot destroy or deteriorate the second terminal in the event of an ejection of vent gas and/or particles out of the venting outlet.

In embodiments, the first cover may be gas-tightly connected with the second cover. Then, the venting space (sub-divided into a plurality of venting channels as described above) is confined by the first cover, the second cover, and the venting sides of the battery cells. Also, each or some of the venting channel openings may be formed by openings in the first cover and/or by openings in the second cover. Also, each or some of the venting channel openings may be formed between the first cover and the second cover.

In one embodiment of the battery module, each or some of the ducts are formed by a space between the first cover and the second cover.

In one embodiment of the battery module, the degassing space is arranged, when viewing into a third direction oriented non-parallel to (e.g., crossing) the first direction and non-parallel to the second direction, after the venting space.

The third direction may be perpendicular to the first direction. The third direction may be perpendicular to the second direction. The third direction may be perpendicular to the first direction as well as to the second direction.

In one embodiment of the battery module, each of the battery cells has a first lateral side facing into the third direction. The degassing space is arranged adjacent to the first lateral sides.

As described above, the degassing space extends along the first direction over the length of the battery cell stack and besides the venting space. Thus, in the afore-mentioned embodiment, the degassing space extends, with regard to the third direction, with one portion (e.g., an upper portion) besides the venting space, and at the same time, with another portion (e.g., a lower portion) adjacent to the first lateral sides of the battery cells in the battery cell stack. Hence, in other words, with regard to the second direction, the venting space is located at the same side of the degassing space as the battery cell stack.

In one embodiment of the battery module, the collection area is essentially planar and arranged non-parallel to the third direction. Each of the venting channel openings opens into the degassing space into the third direction. The collection area is arranged spaced apart from each of the venting channel openings with regard to the third direction.

In such embodiments, vent gas including entrained particles may be effused through one or more of the venting channels via the respective venting channel openings into the third direction. Because the collection area is arranged non-parallel to the third direction and opposite to each of the venting channel openings, the particles—essentially following their flow direction after having been effused into the third direction—impinge onto the collection area, where they subsequently may stick and/or become sintered. The particles are most likely to stick if they arrive on the collection area at an angle of about 90°.

Hence, in embodiments, the collection area may be arranged perpendicular or essentially perpendicular to the third direction. Also, in embodiments, the collection area may be arranged parallel to the first direction (e.g., parallel to the stacking direction of the battery cells). The collection area may be arranged such that the distances between each of the venting channel openings and the collection area are equal. Then, any particles, when traversing the degassing space on their trajectory from a venting channel opening to the collection area, traverse across the same distance.

In embodiments, the wall may be planar or essentially planar and arranged in the same virtual plane as the collection area.

In embodiments, the collection area may be formed integrally with the wall.

In embodiments, the first lateral sides of the battery cells may be separated from the degassing space by a shielding barrier. The shielding barrier may be made of material having relatively poor heat conductivity. By the shielding barrier, the battery cells are thermically isolated or shielded from the hot venting gas collected and streaming in the degassing space.

The degassing space may include one or more discharge outlets configured for discharging vent gas to the outside of the battery module.

In one embodiment of the battery module, the degassing space is a sidewall chamber of the battery module or is a floor separation chamber of the battery module.

In embodiments, the wall including the collection area is a confinement (e.g., a sidewall) of the sidewall chamber of the battery module or the floor separation chamber of the battery module.

In embodiments, the wall is made of metal.

In embodiments, the collection area is made of metal.

In embodiments, the wall is additionally reinforced with a metal plate in the region of the collection area.

In embodiments, the confining member may be covered by a top cover of the battery module, and the top cover may be arranged opposite, with regard to the confining member, to the venting sides of the battery cells. In other words, a space between the top cover of the battery module and the venting sides of the battery cells is used to accommodate the confining member and, thus, the venting space.

According to embodiments of the present disclosure, a battery module enables sticking and/or sintering of particles (e.g., metallic and graphite particles) entrained in the venting gas ejected from a cell during a thermal runaway inside the battery module at a dedicated and electrically safe location.

A second embodiment of the present disclosure is related to a battery system including one or more battery modules as described herein.

A third embodiment of the present disclosure refers to a vehicle including at least one battery module as described herein and/or at least one battery system as described herein.

The vehicle may be a hybrid vehicle or a fully electric vehicle.

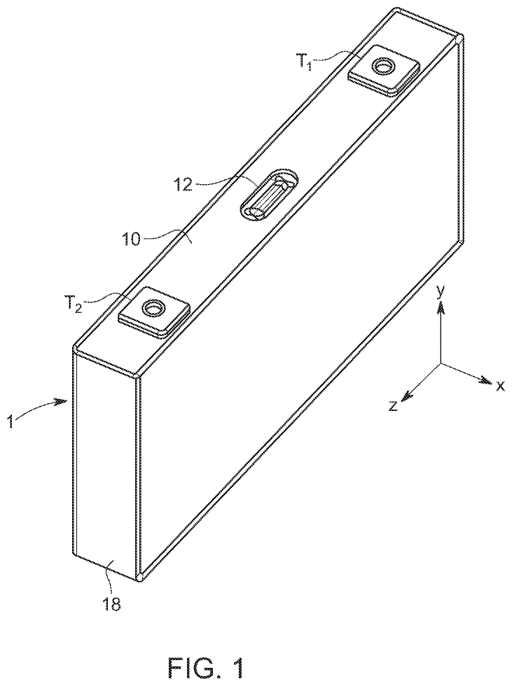

A battery module or battery system generally includes one or more stacks of battery cells. The individual battery cells within one of those stacks are generally shaped identically or essentially identically to each other. As an example, a typical battery cell 1 used in a battery cell stack is schematically illustrated in FIG. 1 with reference to a Cartesian coordinate system in a perspective view. The battery cell 1 has a prismatic (e.g., cuboid) shape. The battery cell 1 has a first terminal T₁ and a second terminal T₂ arranged on an upper side surface 10 thereof (e.g., the battery cell's 1 side surface facing in the y-direction of the coordinate system). The terminals T₁, T₂ allow for an electrical connection to the battery cell 1. The first terminal T₁ may be a negative terminal of the battery cell 1, and the second terminal T₂ may be a positive terminal of the battery cell 1. Furthermore, a venting outlet 12 is arranged on the upper side surface 10 between the first terminal T₁ and the second terminal T₂. Accordingly, the upper side surface 10 will hereinafter be referred to as the “venting side” of the battery cell 1.

Vent gas can be ejected (or emitted) from the battery cell 1 through the venting outlet 12 in the case of a thermal event occurring in the battery cell 1, such as a thermal runaway. A valve is often installed upstream of the venting outlet 12 inside the battery cell 1, and the valve is configured to open if the gas pressure inside the battery cell 1 exceeds a reference (or predefined) value but remains in a closed stated otherwise (e.g., when the gas pressure inside the battery cell 1 is below the reference value). Thus, before being output (or emitted) via the venting outlet 12, the vent gas may pass the venting valve arranged inside the battery cell 1.

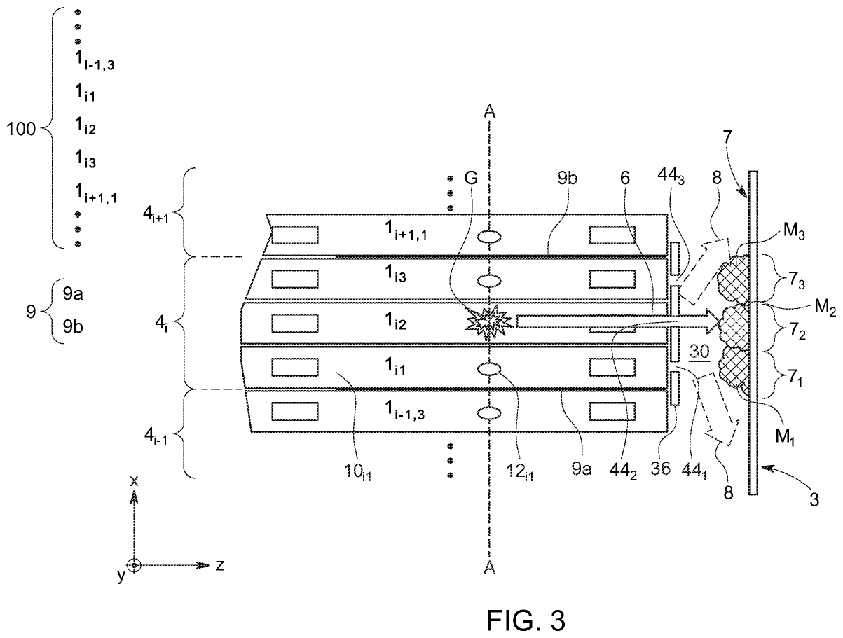

By stacking together a plurality of battery cells, each being designed similar to the battery cell 1 shown in FIG. 1, along a first direction parallel to the x-direction (or x-axis) of the coordinate system, a stack of battery cells is formed (see, e.g., the stack 100 including the battery cells 1_{i-1,3}, 1ᵢ₁, 1ᵢ₂, 1ᵢ₃, and 1_{i+1,1} schematically depicted in FIG. 3).

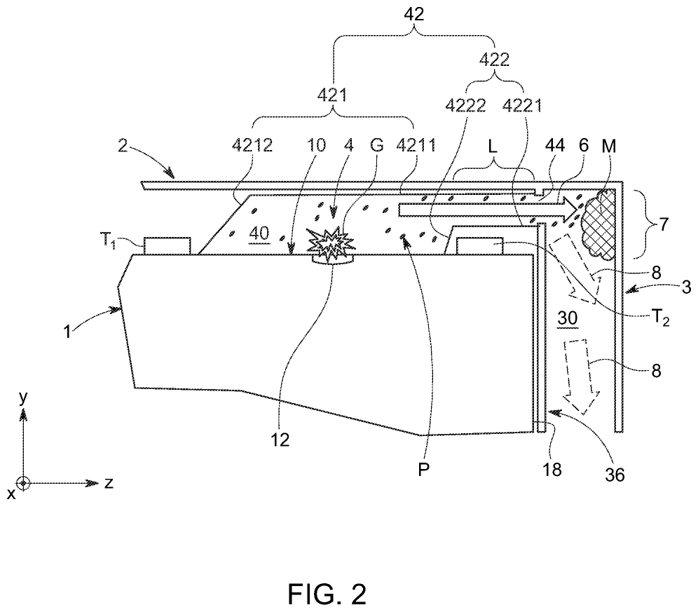

FIG. 2 is a schematic cross-sectional view of a battery module according to an embodiment of the present disclosure. Here, the cross-section is taken through one of the battery cells 1 aligned in a battery cell stack along a first direction (e.g., the x-direction) similar to the battery cell stack 100 depicted in FIG. 3, to be described later. The battery module is confined by a top wall 2 in the y-direction and is confined by a side wall 3 in the z-direction. In FIG. 2, the battery cell 1 may be shaped identically or similar to the battery cell 1 described above with reference to FIG. 1. The battery cell 1 is shown as being in a state of the thermal event. Thus, hot vent gas G generated inside the battery cell 1 is being ejected out of the battery cell 1 via the venting opening 12 arranged in the venting side 10 of the battery cell 1 as indicated by the schematic flame depicted above the venting opening 12. Particles P, indicated by the small dots, such as metallic and/or graphite particles, may be entrained with (or suspended in) the vent gas. When electrical installations and members, such as the first and second terminals T₁, T₂ of the battery cell 1, as well as in other regions of the battery module (e.g., busbars electrically interconnecting the terminals of different battery cells 1 or measurement devices, such as temperature sensors) come into contact with the vent gas G, these electrical installations and members may be seriously deteriorated or even completely destroyed by the vent gas G and/or the particles P carried along with the vent gas G.

However, the ejected vent gas G cannot move freely around within the battery module because the vent gas G is first collected in a venting space 40 arranged above the venting side 10 of the battery cell 1. The venting space 40 is the void between the venting side 10 and the top wall 2 of the battery module. Further, in the illustrated embodiment, the venting space 40 is confined by a confining member 42. The confining member 42 is, in one embodiment, made of a high-temperature resistant material. Also, the material of the confining member 42 is, in one embodiment, also electrical insulating. Then, arcing between the top wall 2 and high voltage parts (e.g., busbars) is prevented.

In the illustrated embodiment, the confining member 42 includes a first cover 421 at least partially spaced apart from the venting side 10 of the battery cell 1 in the y-direction. The first cover 421 has, with regard to the orientation of the battery module as shown in FIG. 2, a horizontal portion 4211 extending under an area of the top wall 2 and an inclined portion 4212 inclined with respect to the venting side 10 and connected to the latter between the venting opening 12 and the first terminal T₁ besides the first terminal T₁. The inclined portion 4212 of the first cover 421 extends in the x-direction across the entire area of the venting side 10 of the battery cell 1. This way, the venting space 40 is also confined in the z-direction before the position of the first terminal T₁. Thus, the first terminal T₁ is shielded from the hot vent gas G collected above the venting side 10 of the battery cell 1 as well as from particles P carried along with the vent gas G.

Similarly, in the embodiment shown in FIG. 2, the confining member 42 further includes a second cover 422 at least partially spaced apart from the venting side 10 of the battery cell 1 with regard to the y-direction. The second cover 422 has, with regard to the orientation of the battery module as shown in FIG. 2, a horizontal portion 4221 extending above an area of the venting side 10 at where the second terminal T₂ is arranged and an inclined portion 4222 inclined with respect to the venting side 10 and connected to the horizontal portion 4221 between the venting opening 12 and the second terminal T₂ besides the second terminal T₂. The inclined portion 4222 of the second cover 422 extends in the x-direction across the entire area of the venting side 10 of the battery cell 1. This way, the venting space 40 is also confined, at least partially (e.g., except for venting channel openings 44, to be described later), in the z-direction before the position of the second terminal T₂. Thus, the second terminal T₂ is also shielded from the hot vent gas G collected above the venting side 10 of the battery cell 1 as well as from particles P carried along with the vent gas G.

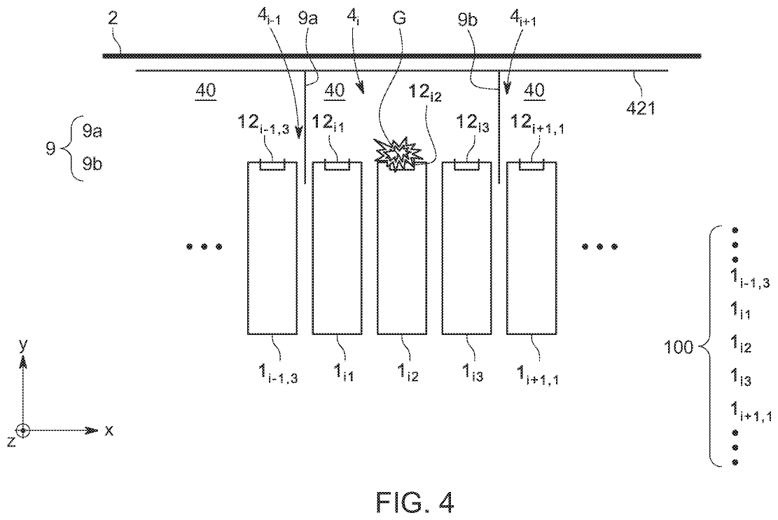

Furthermore, as will be described in further detail below with reference to FIGS. 3 and 4, the venting space 40, which is confined by the confining member 42, is sub-divided by a plurality of separators 9a, 9b into a plurality of compartments or chambers that are consecutively arranged parallel the x-direction. In other words, each of these compartments or chambers is confined, with regard to any cross-section parallel to the y-z-plane of the coordinate system, by the confining member 42 as described above, and further, with regard to the x-direction, by two neighboring ones of the separators 9a, 9b. Thus, the cross-section taken perpendicular to the x-direction (between two neighboring separators) of one of those compartments or chambers 4 is identical with the cross-sectional profile of the venting space 40 as shown in FIG. 2. Each of these compartments or chambers 4, 4ᵢ₋₁, 4ᵢ, 4ᵢ₊₁ (see, e.g., FIG. 4) has one or more openings 44 through which vent gas G as well as particles P entrained with the vent gas G can escape. The positions of the one or more openings 44 determine the outflow direction of the vent gas G. Hence, the compartments or chambers 4, 4ᵢ₋₁, 4ᵢ, 4ᵢ₊₁ each act as a venting channel within which vent gas G and particles P ejected from one or more battery cells 1 arranged below the venting channel is first collected, and through which the vent gas G and the particles P are then guided to the outside of the venting channel in a direction (e.g., a predefined direction). Thus, the compartments or chambers as described above are referred to as venting channels 4, 4ᵢ₋₁, 4ᵢ, 4ᵢ₊₁ herein, and the openings configured for the effusion of the vent gas G will accordingly be referred to as venting channel openings 44.

The cross-sectional profile of venting channel 4 can be taken from FIG. 2. For example, in the embodiment shown in FIG. 2, a venting channel opening 44 is arranged in the confining member 42 such that the vent gas G and particles P are guided into the z-direction when escaping from the venting channel 4 (indicated by arrow 6 in FIG. 2). That is, the vent gas G and particles P leave the venting channel 4 in a direction perpendicular to the direction of the battery cell stack, which is arranged along the x-direction. In the illustrated embodiment, the venting channel opening 44 is formed in a region L along the z-direction between a portion of the first cover 421 and a portion of the second cover 422 of the confining member 42. Hence, in the illustrated embodiment, the venting channel opening 44 forms a duct extending along the z-direction in the region L. When viewing against the z-direction, various shapes of the venting channel opening 44 are possible. For example, the venting channel opening 44 may have a circular shape when viewing against the z-direction. Then, any cross-section profile of the duct (e.g., the cross-section taken parallel to the y-z-plane of the coordinate system, that is, parallel to the drawing plane of FIG. 2) formed by venting channel opening 44 may exhibit a circular shape. However, the venting channel opening 44 when viewing against the z-direction may have different shapes, for example, a square shape, a rectangular shape, a slit shape, or an oval shape.

Generally, the smaller the cross-sectional profile of the venting channel opening 44 (with regard to the x-y-plane of the coordinate system), the greater the outflow velocity of the vent gas G and the particles P effused from the venting channel opening 44 (for a certain pressure of the vent gas G inside the venting channel 4, which in turn depends on the volume of the interior of venting channel 4 and the temperature of the vent gas G inside the venting channel 4). Thus, the outflow velocity of the vent gas G and the particles P can be controlled according to the cross-section of the venting channel opening 44.

Also, the duct formed by the venting channel opening 44 may taper when viewing from the venting channel 4 into the z-direction. Then, the vent gas G and the particles P may be accelerated while passing through the duct such that their velocity is increased.

Each of the venting channel openings 44 opens into a degassing space 30, which extends, with regard to the orientation of the battery module as depicted in FIG. 2, on the right side of the battery cell stack 100 and, thus, on the right side of the individual battery cells 1. In the illustrated embodiment, the degassing space 30 is confined, on the right side in the z-direction, by the wall 3 and on the top side in the y-direction, by the top wall 2. In this embodiment, the degassing space 30 is a sidewall chamber of the battery module. With regard to the y-direction, the degassing space 30 extends, with a lower portion, along a lateral side 18 of battery cell 1, and an upper portion of the degassing space is adjacent the venting channel 4 such that the venting channel opening 44 connects (e.g., fluidly connects) the venting channel 4 with the degassing space 30. Hence, after being effused from the venting channel opening 44, the vent gas G is collected in the degassing space 30. The degassing space 30 may further have a discharge outlet configured for finally discharging the vent gas G to the outside of the battery module. For example, with regard to FIG. 2, the discharge outlet may be arranged in an area somewhere below the region depicted in FIG. 2. Accordingly, the vent gas G is guided against the y-direction inside the degassing space 30 as indicated by the arrows 8 and, thus, perpendicular to the outflow direction (z-direction) of the vent gas G upon being effused from the venting channel opening 44 been indicated by the arrow 6. In other words, after being effused from the venting channel opening 44, the flow direction of the vent gas G (e.g., the flow direction of the molecules of the vent gas G) is deflected (or changed) from the z-direction into a direction against the y-direction such the flow trajectory of the vent gas molecules is curved, in particular, within the upper portion of the degassing space 30.

Moreover, the lateral side 18 of the battery cell 1 is separated from the degassing space 30 by a shielding barrier 36. The shielding barrier 36 may be made of a material having relatively low heat conductivity. The shielding barrier 36 thermally isolates or shields the battery cell 1 from the hot venting gas G collected and streaming in the degassing space 30 as indicated by the arrows 8.

The metallic or graphite particles P entrained with the vent gas G are small lumps of solid material. Hence, the particles P have a much higher weight than the molecules of the vent gas G. Accordingly, inertia makes it much harder for these particles P to be deflected from their trajectory than the vent gas molecules. Thus, the trajectory of the particles P exhibits no or just a very small curvature after being effused from the venting channel opening 44. Consequently, the particles P (or at least a majority of the particles P) do not manage to change their trajectory to follow the direction of flow in the degassing space against the y-direction. Instead, the particles P cross the entire interior of the degassing space 30 with regard to the z-direction and contact (or impact) an upper area of the wall 3 confining the degassing space 30 on the right side with regard to the orientation of FIG. 2. Hereinafter, the upper area of wall 3 at where the particles P impinge the wall 3 will be referred to as collection area 7. After the particles P hit (e.g., contact or impact) the collection area 7, the particles P will remain stuck on the collection area 7 and may become sintered there. Consequently, the particles P are no longer carried along with the vent gas G. As a result, the vent gas G guided through the remaining part of the degassing space 30, that is, with regard to FIG. 2, the portion of the degassing space 30 below the collection area 7, has been separated from the particles P such that, when the vent gas G is discharged from the degassing space 30 (and, thus, from the battery module), the vent gas G entering the outside of the battery module is free or substantially free of metallic and graphite particles P. The afore described sticking and sintering of the particles P on the collection area 7 is more complete the hotter the temperature and the velocity of the particles P. Thus, the vent gas G including the particles P should be ejected from the venting channel opening 44 with his sufficient velocity (e.g., kinetic energy), which may be supported or ensured by the shape of the venting channel opening 44, as described above.

FIG. 3 is another schematic cross-sectional view of the battery module shown in FIG. 2. In FIG. 3, the cross-section is taken through the venting space 40 perpendicular to the y-direction, that is, approximately along the arrow 6 indicating the flow direction of the vent gas G and the particles P through the venting channel opening 44 in FIG. 2. FIG. 3 shows the arrangement of the plurality of individual battery cells 1_{i-1,3}, 1ᵢ₁, 1ᵢ₂, 1ᵢ₃, 1_{i+1,1}, each of which may be shaped identically or similar to the battery cell 1 described above with reference to FIG. 1, as a stack 100 of battery cells 1 orientated along the x-direction. In particular, FIG. 3 provides a top view of the battery cell stack 100. Of course, the battery cell stack 100 may include more battery cells 1 than are illustrated, which is indicated by the dots on either side of the illustrated battery cells in FIG. 3. In the illustrated embodiment, a first separator 9a is arranged between the battery cell 1_{i-1,3} depicted lowermost in FIG. 3 and the battery cell 1ᵢ₁ arranged next to the battery cell 1_{i-1,3} in the x-direction. Similarly, a second separator 9b is positioned between the battery cell 1_{i+1,1} depicted uppermost in FIG. 3 and the battery cell 1ᵢ₃ placed next to the battery cell 1_{i+1,1} against the x-direction. Thus, a group of the battery cells including the battery cells 1ᵢ₁, 1ᵢ₂, 1ᵢ₃ is arranged between the first separator 9a and the second separator 9b. This configuration may be continued in the x-direction and against the x-direction along the entire length of the battery cell stack 100. For example, the battery cell stack 100 may include a number of battery cells (e.g., 3N battery cells), and any group of three neighboring battery cells may be arranged between two separators. Then, the battery cell stack 100 includes N groups of battery cells, which may be indicated by a number i∈{1, . . . , N}. In FIG. 3, the group of battery cells 1ᵢ₁, 1ᵢ₂, 1ᵢ₃ may be the i-th group in the battery cell stack 100. Further, each of the separators may extend, in the z-direction, along the border between two adjacent battery cells 1.

In FIG. 3, the battery cell 1i2 that is centered in the illustrated portion of the battery cell stack 100 is undergoing a thermal event while the remaining battery cells 1_{i-1,3}, 1ᵢ₁, 1ᵢ₃, 1_{i+1,1} are in a normal state. Thus, the battery cell 1ᵢ₂ can be identified with the battery cell 1 shown in FIG. 2. Accordingly, hot vent gas G is ejected from battery cell 1ᵢ₂, which is again indicated by a flame symbol. The ejected vent gas G collects in the venting space 40 as described above with reference to FIG. 2. In particular, the venting space 40 is confined, with regard to the y-direction and the z-direction, by a first cover 421 and the second cover 422 of the confining member 42 (which are not shown in FIG. 3 for convenience of description). However, along the x-direction, the venting space 40 is sub-divided into a plurality of venting channels by a number of the separators. In FIG. 3, the venting channel 4 is formed between the first separator 9a and the second separator 9b. When battery cell 1ᵢ₂ is identified with the battery cell 1 shown in FIG. 2, the venting channel 4 in FIG. 3 corresponds to the venting channel 4 in FIG. 2. In the x-direction, a further venting channel 4ᵢ₊₁ (see, e.g., FIG. 4) is arranged between the second separator 9b and a further separator. Correspondingly, another venting channel 4ᵢ₋₁ (see, e.g., FIG. 4) is arranged between the first separator 9a and another separator.

The venting channels 4ᵢ₋₁, 4ᵢ, 4ᵢ₊₁ are separated in a gas-tight manner from each other by the separators 9a, 9b. Thus, venting gas collected in the venting channel 4ᵢ after being ejected from battery cell 1ᵢ₂ cannot get into (e.g., cannot move into) one or both of the neighboring venting channels 4ᵢ₋₁, 4ᵢ₊₁. Thus, at most, only the battery cells 1ᵢ₁, 1ᵢ₃ that directly neighbor the battery cell 1ᵢ₂ may be affected by (e.g., exposed to) the vent gas G because they are in the same i-th group of battery cells of the battery cell stack 100 as the battery cell 1ᵢ₂. All remaining battery cells 1 in the battery cell stack 100 are shielded from the vent gas because the vent gas G is impeded or prevented from entering into the venting channels arranged adjacent to their respective venting sites.

Moreover, the vent gas G can only exit the venting channel 4ᵢ through the one or more venting channel openings 44₁, 44₂, 44₃ in the confining member 42 as described above with reference to FIG. 2. In the illustrated embodiment, one venting channel opening is provided per battery cell. So, with respect to the x-direction, venting channel opening 44₁ is arranged in the area of battery cell 1ᵢ₁, venting channel opening 44₂ is arranged in the area of battery cell 1ᵢ₂, and venting channel opening 44₃ is arranged in the area of battery cell 1ᵢ₃. However, the number of venting channel openings provided for venting channel may not correspond to the number of battery cells arranged within the corresponding venting channel. Here, venting channel opening 44₂ show in FIG. 3 may correspond to venting channel opening 44 shown in FIG. 2. As already described with reference to FIG. 2, the vent gas G including the entrained particles P leaves the venting channel 4ᵢ through the venting channel openings. Because the gas pressure of the vent gas G is equal everywhere inside the venting channel 4ᵢ, the vent gas streams out of the venting channel 4ᵢ through each of the venting channel openings 44₁, 44₂, 44₃.

Thus, the vent gas G including particles P is effused into the degassing space 30 into the z-direction from any of the venting channel openings 44₁, 44₂, 44₃ of venting channel 4ᵢ. However, due to the trajectories of the vent gas molecules and the particles being different from each other due to the different material properties of the vent gas molecules and the particles (see the detailed explanation above in the context of FIG. 2), the particles will separate from the vent gas and impinge against the collection area 7 of the wall 3 where they will sinter and remain stuck. As particles are ejected from each of the venting channel openings 44₁, 44₂, 44₃ of the venting channel 4ᵢ, three clusters M₁, M₂, M₃ of particles P may be deposited in corresponding regions 7₁, 7₂, 7₃ opposite to the venting channel openings 44₁, 44₂, 44₃ on the collection area 7.

The remaining vent gas G, devoid of the particles P, is guided through the degassing space 30 until it reaches one or more discharge outlets, through which the vent gas G is discharged to the outside of the battery module. Within the degassing space 30, the vent gas G may be guided in any direction perpendicular to the streaming direction of the vent gas G upon being effused from venting channel openings 44₁, 44₂, 44₃ (indicated by arrow 6), that is, in any direction perpendicular to the z-direction (as indicated by the arrows 8 in FIGS. 2 and 3).

The above description with reference to FIGS. 2 and 3 may be summarized as follows. Hot venting gas G and particles P ejected from the battery cell 1 (1ᵢ₂) in the state of a thermal event (such as a thermal runaway) will exit the battery cell 1 (1ᵢ₂) at the location of the venting outlet 12 (12ᵢ₂) and will be guided by the venting channel 4 (4ᵢ) formed by a confining member 42 into the degassing space 30, which may be a sidewall chamber of the battery module. Because of the hot temperature and high speed of the venting gas G and particles P, the metallic and graphite particles P will sinter onto the collection area 7 of the wall 3 and will remain stuck there. This is indicated in FIG. 2 by the deposit of accumulated material M opposite to venting channel opening 44 and in FIG. 3 by the deposit M₂ of sintered material in the region 7₂ of the collection area 7 located opposite to the venting channel opening 44₂. In case of a thermal event in other battery cells, the particles of these cells will (substantially) impinge and stick on other areas of the collection area 7. For example, particles ejected from battery cells 1ᵢ₁ and 1ᵢ₃ will (substantially) impinge onto the regions 7₁ and 7₃ of the collection area 7, respectively, and finally stick and sinter on these locations.

The sintered particles will never reach the exit of the battery module or the battery pack, within which the battery module is included. Thus, the discharge channels will remain clean in case more or even all of the battery cells are triggered in the course of a thermal propagation. Moreover, the discharge channel formed by the degassing space 30 in the sidewall of the battery module is only partly blocked at the regions 7, 7₁, 7₂, 7₃, at where the particles P ejected from the battery cells 1 accumulate. Because the stuck material remains always (substantially) next to the battery cell (in a first deposit) from which it has been ejected, while the ejected particles of each of the other venting battery cells will cause particle deposition inside the degassing space (substantially) only besides (e.g., parallel to) the first deposit.

Moreover, because the degassing space (and, in particular, the wall 3 including the collection area 7) is at the electrical potential of the vehicle's chassis (e.g., is grounded), while the high voltage sections of the battery cells are each insulated, an arc to the chassis cannot happen.

Of course, because the only exits of the venting space 40 are formed by the venting channel openings 44 leading into the degassing space 30, not only are the terminals T₁, T₂ protected from vent gas G and particles P but other electrical installations and members are also protected because vent gas G and particles P can only be present within the venting space 40 and the degassing space 30.

The remaining venting gas G with some remainder of dust (e.g., particles) will exit the battery module through the lower portion of the venting space 30 arranged in the sidewall chamber of the battery module. After exiting from the battery module, the cleaned vent gas G may still pass a main venting unit, before finally exiting into the ambient air.

FIG. 4 supplements the foregoing figures in that it provides a further schematic cross-sectional view of the battery module shown in FIGS. 2 and 3 taken along the axis indicated by A-A in FIG. 3. Again, the five consecutively arranged battery cells 1_{i-1,3}, 1ᵢ₁, 1ᵢ₂, 1ᵢ₃, 1_{i+1,1} of in battery cell stack 100 are depicted, and the battery cell stack 100 extends along the x-direction. The presence of further battery cells 1 in and against the x-direction is indicated by the triple dots. In FIG. 4, the battery cells 1 are depicted with an interstice between any two adjacent ones of battery cells 1. The interstice may, however, be exaggerated in the drawing for convenience of description. In embodiments, adjacent ones of the battery cells 1 may directly abut against each other such that no interstice is present between adjacent battery cells 1. However, when an interstice is present between two adjacent ones of the battery cells 1, the space between the two battery cells 1 may be filled by a material, for example, by an adhesive, with which the two battery cells 1 are glued to each other. In any case, the void space between two adjacent battery cells should be minimized or avoided.

Above the venting sides 12_{i-1,3}, 12ᵢ₁, 12ᵢ₂, 12ᵢ₃, 12_{i+1,1} of the plurality of battery cells 1_{i-1,3}, 1ᵢ₁, 1ᵢ₂, 1ᵢ₃, 1_{i+1,1}, the venting space 40 is arranged, which extends, along the y-direction, between the venting sides 12_{i-1,3}, 12ᵢ₁, 12ᵢ₂, 12ᵢ₃, 12_{i+1,1} and the first cover 421 of the confining member 42. The first cover 421 extends, in turn, below the top wall 2 of the battery module. Along the x-direction, the venting space 40 is gas-tightly sub-divided into a plurality of venting channels 4₁, 4₂, 4₃ such that any exchange of vent gas (including particles) between the individual venting channels 4₁, 4₂, 4₃ is avoided. Accordingly, each of the venting channels 4₁, 4₂, 4₃ is confined in the x-direction by a separator, against the x-direction by a further separator, in the y-direction, by the first cover 421 of the confining member 42, and against the y-direction by venting sides of the battery cells 1 positioned between the aforementioned separators. For example, with reference to the orientation of the battery module in FIG. 4, the venting channel 4₂ is confined at the bottom by the venting sides 12ᵢ₁, 12ᵢ₂, 12ᵢ₃ of battery cells 1ᵢ₁, 1ᵢ₂, 1ᵢ₃, at the top by the first cover 421, on the left side by the first separator 9a, and on the right side by the second separator 9b.

The plurality of battery cells 1 is arranged in the battery cell stack 100 as described before with reference to FIG. 2. The battery cells 1 are grouped into groups of, for example, three battery cells each, and each of the groups, with regard to the x-direction, is arranged between two separators. For example, the i-th group of the battery cell stack 100 including the battery cells 1ᵢ₁, 1ᵢ₂, 1ᵢ₃ is arranged between the first separator 9a and the second separator 9b, which each extends along a virtual plane perpendicular to the drawing plane of FIG. 4. The separators may extend into the interstices between adjacent ones of the battery cells 1. For example, as depicted in FIG. 4, the first separator 9a may protrude into the interstice between the battery cells 1_{i-1,3} and 1ᵢ₁, and the second separator 9b may protrude into the interstice between the battery cells 1ᵢ₃ and 1_{i+1,1}. However, in other embodiments, the separators 9a, 9b may not protrude below the plane, along which the venting sides 12_{i-1,3}, 12ᵢ₁, 12ᵢ₂, 12ᵢ₃, 12_{i+1,1} of the battery cells 1_{i-1,3}, 1ᵢ₁, 1ᵢ₂, 1ᵢ₃, 1_{i+1,1} are arranged.

Finally, a dedicated electrically insulated venting channel formed in the sidewall of a battery module may have at least some of the following aspects and features:

Hot (metallic and graphite) particles P are “stored” locally next the battery cell 1, 1ᵢ₂ from where these particles P where ejected inside the degassing space 30.

Each battery cell 1ᵢ₁, 1ᵢ₂, 1ᵢ₃, from which vent gas G and particles P are ejected forms an individual location 7₁, 7₂, 7₃ at where the particles ejected from the corresponding cell are primarily deposited.

Ejected particles remain P stuck at locations (7, 7₁, 7₂, 7₃) inside the battery module, thus reducing the risk of outside fire.

The degassing space 30 is usually not heavily loaded by clusters or piles of deposited material M₁, M₂, M₃, thus, enough (or sufficient) discharging space remains available within the degassing space 30 even when a plurality or all of the battery cells 1_{i-1,3}, 1ᵢ₁, 1ᵢ₂, 1ᵢ₃, 1_{i+1,1} is affected by (or undergo) a thermal runaway.

No risk or at least considerably reduced risk of short circuits or arcing because the sintered conductive particles (or material) M, M₁, M₂, M₃ is stored in the degassing space 30 and, thus, remains inside the battery module.

High voltage parts within the battery module or the battery pack (e.g., the terminals T₁, T₂ of a battery cell) are electrically insulated by the confining member 42 (e.g., by the first cover 421, the second cover 422, and the first and second separators 9a, 9b) from the chassis potential.

A plurality of battery cells undergoing a thermal runaway will pile up the sintered material along the direction (e.g., the x-direction), along which the battery cell stack 100 is oriented.

The risk of gas ignition outside the battery module (and, thus, outside the battery pack) because of hot particles P exiting the battery system (through a discharge valve) into free ambient air is drastically reduced.

Metal plates on the inner side of wall 3 and, in particular, in the region of the collection area 7, may help to cool down the hot venting gas G to exit with a much lower temperature, thereby considerably reducing the risk of self-ignition.

Some Reference Symbols

| | |
|---|---|
| 1 | battery cell |
| 1_{i-1, 3}, 1ᵢ₁, 1ᵢ₂, | battery cells |
| 1ᵢ₃, 1_{i+1, 1} | |
| 2 | top wall |
| 3 | side wall |
| 4 | venting channel |
| 4ᵢ₋₁, 4ᵢ, 4ᵢ₊₁ | venting channels |
| 6 | arrows indicating vent gas flow within the venting |
| | channel and within the venting channel opening |
| 7 | collection area |
| 7₁, 7₂, 7₃ | regions on collection area |
| 8 | arrows indicating vent gas flow in degassing space |
| 9a, 9b | separators |
| 10 | venting side of battery cell |
| 10ᵢ₁ | venting side of battery cell |
| 12 | venting outlet |
| 12_{i-1, 3}, 12ᵢ₁, 12ᵢ₂, | venting outlets |
| 12ᵢ₃, 12_{i+1, 1} | |
| 18 | lateral side of battery cell |
| 30 | degassing space |
| 36 | shielding barrier |
| 40 | venting space |
| 42 | confining member |
| 44 | venting channel opening |
| 44₁, 44₂, 44₃ | venting channel openings |
| 100 | battery cell stack |
| 421 | first cover |
| 422 | second cover |
| 4211 | horizontal portion of first cover |
| 4212 | inclined portion of first cover |
| 4221 | horizontal portion of second cover |
| 4222 | inclined portion of second cover |
| A - A | indication of cross-section |
| G | venting gas |
| M, M₁, M₂, M₃ | particle deposits/particle clusters |
| P | particles |
| T₁ | first terminal |
| T₂ | second terminal |
| x, y, z | axes of a Cartesian coordinate system |

What is claimed is:

1. A battery module comprising:
a battery cell stack comprising a plurality of battery cells arranged along a first direction, each of the battery cells having a venting side, each of the venting sides facing in a second direction crossing the first direction, each of the venting sides comprising a venting outlet;
a venting space extending along the battery cell stack adjacent to the venting sides, each of the venting outlets opening into the venting space;
a degassing space extending along the first direction besides the venting space; and
a plurality of separators arranged within the venting space and sub-dividing the venting space into a plurality of venting channels arranged along the first direction and being gas-tightly separated from each other by the separators,
wherein each of the venting channels has a venting channel opening open into the degassing space, and
wherein the degassing space is at least partly confined by a wall comprising a collection area, the collection area being arranged opposite to each of the venting channel openings and spaced apart from each of the venting channel openings.

2. The battery module according to claim 1, wherein the separators are each planar, and
wherein the separators are each arranged parallel to a border between two adjacent ones of the battery cells.

3. The battery module according to claim 1, further comprising a confining member configured to spatially confine at least a part of the venting space.

4. The battery module according to claim 3, wherein the respective venting channel opening of at least some of the venting channels is a duct having a smaller cross-section than that of the respective venting channel.

5. The battery module according to claim 4, wherein at least some of the ducts each formed by a narrowed portion of the confining member.

6. The battery module according to claim 4, wherein the confining member comprises a first cover at least partially spaced apart from the venting sides of the battery cells and confining the venting space in the second direction.

7. The battery module according to claim 6, wherein the venting side of each of the battery cells comprises a first terminal, and
wherein, for each of the battery cells, the first cover gas-tightly connects to the venting side of the corresponding battery cell between the first terminal and the venting outlet.

8. The battery module according to claim 7, wherein the venting side of each of the battery cells comprises a second terminal,
wherein the confining member comprises a second cover, and
wherein, for each of the battery cells, the second cover gas-tightly connects to the venting side of the corresponding battery cell between the second terminal and the venting outlet.

9. The battery module according to claim 8, wherein at least some of the ducts are formed by a space between the first cover and the second cover.

10. The battery module according to claim 1, wherein the degassing space is arranged, when viewing into a third direction crossing the first direction and the second direction, after the venting space.

11. The battery according to claim 10, wherein each of the battery cells has a first lateral side facing into the third direction, and
wherein the degassing space is adjacent to the first lateral sides.

12. The battery module according to claim 11, wherein the collection area is planar and is non-parallel to the third direction,
wherein each of the venting channel openings opens into the degassing space in the third direction, and
wherein the collection area is spaced apart from each of the venting channel openings in the third direction.

13. The battery module according to claim 1, wherein the degassing space is a sidewall chamber of the battery module.

14. The battery module according to claim 12, wherein the degassing space is a floor separation chamber of the battery module.

15. A battery system comprising the battery module according to claim 1.

16. A vehicle comprising the battery module according to claim 1.

17. A vehicle comprising the battery system according to claim 15.
